(19) United States
(12) Patent Application Publication
(10) Pub. No.: US 2022/0239171 A1
(43) Pub. Date: Jul. 28, 2022

(54) ROTOR, ELECTRIC MOTOR, BLOWER, AIR CONDITIONER, AND MANUFACTURING METHOD FOR ROTOR

(71) Applicant: Mitsubishi Electric Corporation, Tokyo (JP)

(72) Inventors: Takanori WATANABE, Tokyo (JP); Hiroki ASO, Tokyo (JP); Atsushi MATSUOKA, Tokyo (JP)

(21) Appl. No.: 17/613,620

(22) PCT Filed: Jun. 26, 2019
(86) PCT No.: PCT/JP2019/025338

§ 371 Date: Nov. 23, 2021

(51) Int. Cl. H02K 1/27; H02K 15/03; H01F 41/02; F04D 25/06

(52) U.S. Cl. CPC H02K 1/27; H02K 15/03; F24F 13/00; F04D 25/06; H01F 41/0266

(57) ABSTRACT

A rotor includes at least one first permanent magnet and a second permanent magnet and has 2n (n is a natural number) magnetic poles. The at least one first permanent magnet forms part of an outer peripheral surface of the rotor and is magnetized to have polar anisotropy. The second permanent magnet is adjacent to the at least one first permanent magnet in a circumferential direction of the rotor, and has lower magnetic force than magnetic force of the at least one first permanent magnet. The second permanent magnet has 3×2n magnetic poles.

### TECHNICAL FIELD

The present invention relates to a rotor for use in an electric motor.

### BACKGROUND ART

As a rotor for use in an electric motor, a rotor having two types of magnets is generally employed (see, for example, Patent Reference 1). In Patent Reference 1, permanent magnets having high magnetic force (also referred to as first permanent magnets) form the entire outer peripheral surface of the rotor, and permanent magnets having lower magnetic force than that of the first permanent magnets (also referred to as second permanent magnets) are disposed inside the first permanent magnets. In this rotor, since the first permanent magnets form the entire outer peripheral surface of the rotor, magnetic force of the rotor can be effectively enhanced.

### PRIOR ART REFERENCE

### Patent Reference

Patent Reference 1: Japanese Patent Application Publication No. 2005-151757

### SUMMARY OF THE INVENTION

### Problem to be Solved by the Invention

In the case where the first permanent magnets having high magnetic force form the entire outer peripheral surface of the rotor, however, sufficient magnetic force of the rotor can be obtained, but since magnets having high magnetic force are generally expensive, costs for the rotor increase disadvantageously.

It is therefore an object of the present invention to obtain sufficient magnetic force of a rotor even in the case of reducing the amount of a first permanent magnet having high magnetic force.

### Means of Solving the Problem

A rotor according to an aspect of the present invention is a rotor having 2n (n is a natural number) magnetic poles, and the rotor includes:

at least one first permanent magnet forming part of an outer peripheral surface of the rotor and magnetized to have polar anisotropy; and

at least one second permanent magnet that is of a different type from the at least one first permanent magnet, is adjacent to the at least one first permanent magnet in a circumferential direction of the rotor, has lower magnetic force than magnetic force of the at least one first permanent magnet, and is magnetized to have polar anisotropy, wherein

the at least one second permanent magnet has 3×2n magnetic poles.

A rotor according to another aspect of the present invention is a rotor having 2n (n is a natural number) magnetic poles and including a plurality of layered magnets including two to m (m is a natural number and a divisor of n) layers that are stacked in an axial direction, wherein

each layered magnet of the plurality of layered magnets includes

at least one first permanent magnet forming part of an outer peripheral surface of the rotor and magnetized to have polar anisotropy, and

at least one second permanent magnet that is of different type from the at least one first permanent magnet, is adjacent to the at least one first permanent magnet in a circumferential direction of the rotor, has lower magnetic force than magnetic force of the at least one first permanent magnet, and is magnetized to have polar anisotropy,

the at least one second permanent magnet has 3×2n magnetic poles, and

in each first permanent magnet of the plurality of layered magnets, supposing one cycle is an angle formed by adjacent north poles in a plane orthogonal to the axial direction of the rotor, positions of north poles of two first permanent magnets adjacent to each other in the axial direction are shifted from each other by n/m cycles in the circumferential direction.

### Effects of the Invention

According to the present invention, even when the amount of first permanent magnets having high magnetic force is reduced, sufficient magnetic force of the rotor can be obtained.

### BRIEF DESCRIPTION OF THE DRAWINGS

FIG. 1 is a side view schematically illustrating a structure of a rotor according to a first embodiment of the present invention.

FIG. 2 is a plan view schematically illustrating the structure of the rotor.

FIG. 3 is a diagram illustrating orientation of first permanent magnets in the rotor.

FIG. 4 is a diagram illustrating a structure of the first permanent magnets and positions of magnetic poles in the first permanent magnets.

FIG. 5 is a cross-sectional view schematically illustrating a structure of a second permanent magnet.

FIG. 6 is a diagram illustrating a structure of the second permanent magnet and positions of magnetic poles in the second permanent magnet.

FIG. 7 is a flowchart depicting an example of a process for fabricating a rotor.

FIG. 8 is a cross-sectional view schematically illustrating a structure of a rotor according to a first comparative example.

FIG. 9 is a diagram illustrating a structure of first permanent magnets and orientation of the first permanent magnets in a rotor according to a second comparative example.

FIG. 10 is a diagram illustrating a structure and orientation of a second permanent magnet in the rotor according to the second comparative example.

FIG. 11 is a diagram illustrating a structure and orientation of the rotor according to the second comparative example.

FIG. 12 is a graph showing changes in surface magnetic flux density.

FIG. 13 is a cross-sectional view schematically illustrating a structure of a rotor according to a first variation.

FIG. 14 is a plan view schematically illustrating a structure of a rotor according to a second variation.

FIG. 15 is a side view schematically illustrating the structure of the rotor according to the second variation.

FIG. 16 is a cross-sectional view schematically illustrating the structure of the rotor according to the second variation.

FIG. 17 is a plan view schematically illustrating a structure of a rotor according to a third variation.

FIG. 18 is a side view schematically illustrating the structure of the rotor according to the third variation.

FIG. 19 is a cross-sectional view schematically illustrating the structure of the rotor according to the third variation.

FIG. 20 is a cross-sectional view schematically illustrating a structure of a rotor according to a fourth variation.

FIG. 21 is a side view schematically illustrating the structure of the rotor according to the fourth variation.

FIG. 22 is a cross-sectional view schematically illustrating a structure of a rotor according to a fifth variation.

FIG. 23 is a side view schematically illustrating the structure of the rotor according to the fifth variation.

FIG. 24 is a partial cross-sectional view schematically illustrating a structure of an electric motor according to a second embodiment of the present invention.

FIG. 25 is a diagram schematically illustrating a structure of a fan according to a third embodiment of the present invention.

FIG. 26 is a diagram schematically illustrating a configuration of an air conditioner according to a fourth embodiment of the present invention.

### MODE FOR CARRYING OUT THE INVENTION

### First Embodiment

In an xyz orthogonal coordinate system shown in each drawing, a z-axis direction (z axis) represents a direction parallel to an axis Ax of a rotor 2, an x-axis direction (x axis) represents a direction orthogonal to the z-axis direction (z axis), and a y-axis direction (y axis) represents a direction orthogonal to both the z-axis direction and the x-axis direction. The axis Ax is a rotation center of the rotor 2. The axis Ax also represents an axis of an electric motor 1 described later. A direction parallel to the axis Ax is also referred to as an “axial direction of the rotor 2” or simply as an “axial direction.” The “radial direction” refers to a radial direction of the rotor 2 or a stator 3, and is a direction orthogonal to the axis Ax. An xy plane is a plane orthogonal to the axial direction. An arrow D1 represents a circumferential direction about the axis Ax. The circumferential direction of the rotor 2 or the stator 3 will be also referred to simply as a “circumferential direction.”

In some drawings, “N” and “S” respectively represent a north pole and a south pole in the rotor 2 (including variations thereof).

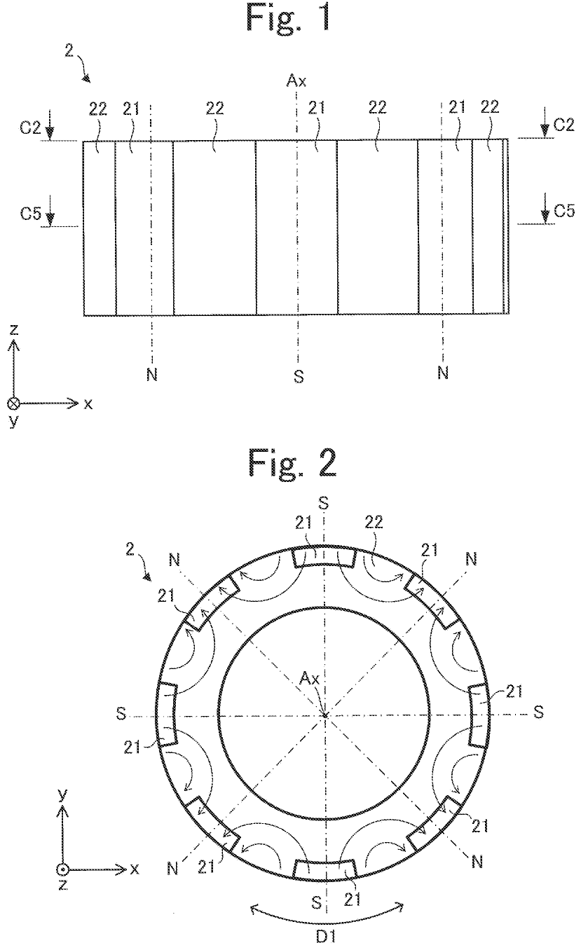

FIG. 1 is a side view schematically illustrating a structure of a rotor 2 according to a first embodiment of the present invention. In FIG. 1, broken lines represent positions of magnetic poles (north poles or south poles) of the rotor 2.

FIG. 2 is a plan view schematically illustrating the structure of the rotor 2. FIG. 2 is a plan view taken along line C2-C2 in FIG. 1. In FIG. 2, arrows on the rotor 2 represent directions of main magnetic flux.

The rotor 2 is used for an electric motor (e.g., an electric motor 1 described later).

The rotor 2 includes at least one first permanent magnet 21 and at least one second permanent magnet 22 that is of a different type from the first permanent magnet 21.

The “at least one first permanent magnet 21” includes two or more first permanent magnets 21. The “at least one second permanent magnet 22” includes two or more second permanent magnets 22.

The rotor 2 has 2n (n is a natural number) magnetic poles. In this embodiment, n is four, and the rotor 2 has eight magnetic poles. The rotor 2 includes the plurality of first permanent magnets 21 and one second permanent magnet 22. In this embodiment, the rotor 2 includes 2n first permanent magnets 21 and one second permanent magnet 22. Thus, in this embodiment, the rotor 2 includes eight first permanent magnets 21 and one second permanent magnet 22.

For example, as illustrated in FIG. 1, north poles of the first permanent magnets 21 and south poles of the first permanent magnets 21 are alternately arranged on the outer peripheral surface of the rotor 2. It should be noted that the plurality of first permanent magnets 21 may be coupled to each other by, for example, ring-shaped coupling parts, and the second permanent magnet 22 may be divided into a plurality of parts.

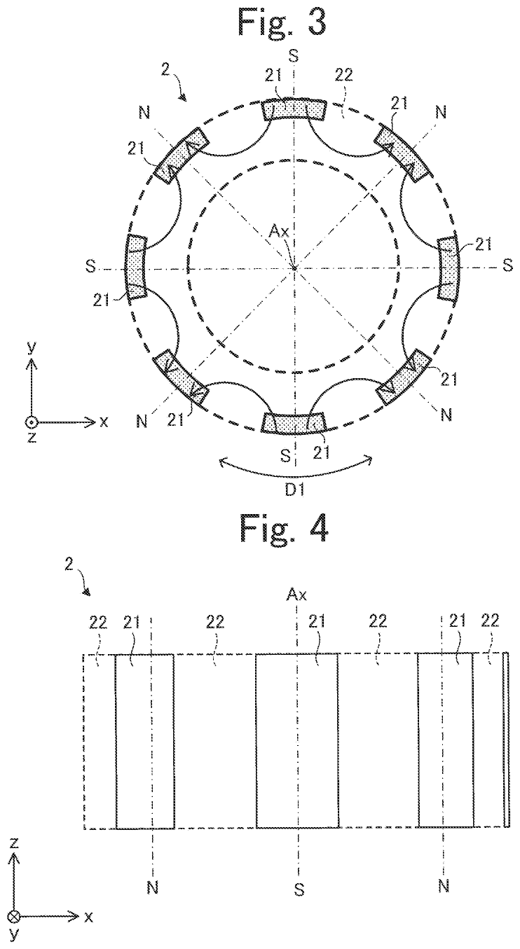

FIG. 3 is a diagram illustrating orientation of the first permanent magnets 21, that is, directions of magnetic flux from the first permanent magnets 21, in the rotor 2.

FIG. 4 is a diagram illustrating a structure of the first permanent magnets 21 and positions of magnetic poles in the first permanent magnets 21.

The first permanent magnets 21 form part of the outer peripheral surface of the rotor 2. As illustrated in FIG. 3, the first permanent magnets 21 are magnetized to have polar anisotropy. In other words, the first permanent magnets 21 are magnetized such that the rotor 2 has polar anisotropy. In this embodiment, as illustrated in FIG. 3, one pair of first permanent magnets 21 (i.e., 2n first permanent magnets 21) form 2n magnetic poles. The first permanent magnets 21 are rare earth magnets. For example, each first permanent magnet 21 is a bonded magnet as a mixture of a rare earth magnet and a resin, that is, a rare earth bonded magnet. Each first permanent magnet 21 has higher magnetic force than that of the second permanent magnet 22.

In the xy plane, the inner peripheral surfaces and the outer peripheral surfaces of the first permanent magnets 21 are concentrically formed. That is, the thickness of the first permanent magnets 21 in the xy plane is uniform in the circumferential direction.

The rare earth magnet is, for example, a magnet containing neodymium (Nd), iron (Fe), and boron (B) or a magnet containing samarium (Sm), iron (Fe), and nitrogen (N). The resin is, for example, a nylon resin, a polyphenylene sulfide (PPS) resin, or an epoxy resin.

The second permanent magnet 22 is adjacent to the first permanent magnets 21 in the circumferential direction of the rotor 2, and forms part of the outer peripheral surface of the rotor 2. Specifically, part of the second permanent magnet 22 is adjacent to the first permanent magnets 21 in the circumferential direction of the rotor 2, and another part of the second permanent magnet 22 is located at the inner side of the first permanent magnets 21 in the radial direction of the rotor 2. Thus, the second permanent magnet 22 is a ring-shaped magnet.

In the examples illustrated in FIGS. 1 and 2, on the outer peripheral surface of the rotor 2, the plurality of first permanent magnets 21 and a plurality of parts of the second permanent magnet 22 are alternately arranged in the circumferential direction of the rotor 2.

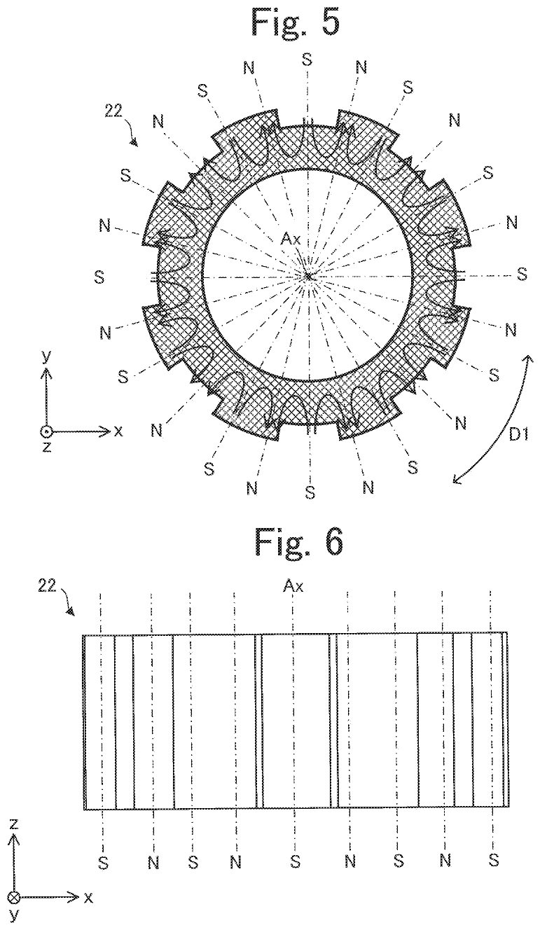

FIG. 5 is a cross-sectional view schematically illustrating a structure of the second permanent magnet 22. FIG. 5 is a cross-sectional view taken along line C5-C5 in FIG. 1. In FIG. 5, arrows on the second permanent magnet 22 represent directions of main magnetic flux.

FIG. 6 is a diagram illustrating a structure of the second permanent magnet 22 and positions of magnetic poles in the second permanent magnet 22.

As illustrated in FIG. 5, the second permanent magnet 22 is magnetized to have polar anisotropy. In other words, the second permanent magnet 22 is magnetized such that the rotor 2 has polar anisotropy. In this embodiment, the second permanent magnet 22 is a single structure, that is, one magnet. The second permanent magnet 22 constitutes magnetic poles in the rotor 2 together with the first permanent magnets 21.

The second permanent magnet 22 is a magnet that is of a different type from the first permanent magnets 21. The second permanent magnet 22 is a ferrite magnet. For example, the second permanent magnet 22 is a bonded magnet as a mixture of a ferrite magnet and a resin, that is, a ferrite bonded magnet. The resin is, for example, a nylon resin, a polyphenylene sulfide (PPS) resin, or an epoxy resin. The second permanent magnet 22 has lower magnetic force than that of each first permanent magnet.

The second permanent magnet 22 has 3×2n magnetic poles. That is, the second permanent magnet 22 has easy axes of magnetization to have 3×2n magnetic poles. Thus, in this embodiment, the second permanent magnet 22 has 24 magnetic poles, and at least 24 easy axes of magnetization.

Orientation of the rotor 2 indicated by arrows in FIG. 2 is a synthesis of orientation of the first permanent magnets 21 illustrated in FIG. 3 and orientation of the second permanent magnet 22 illustrated in FIG. 5. Consequently, the surface magnetic flux density of the rotor 2, that is, the magnetic flux density on the outer peripheral surface of the rotor 2, is at maximum at the boundary between each first permanent magnet 21 and the second permanent magnet 22.

Part of a plurality of magnetic poles (e.g., some north poles) of the second permanent magnet 22 is adjacent to each first permanent magnet 21. Accordingly, the magnetic flux density on the outer peripheral surface of the rotor 2 is at maximum at the boundary between each first permanent magnet 21 and the second permanent magnet 22.

An example of a method for fabricating the rotor 2 will be described.

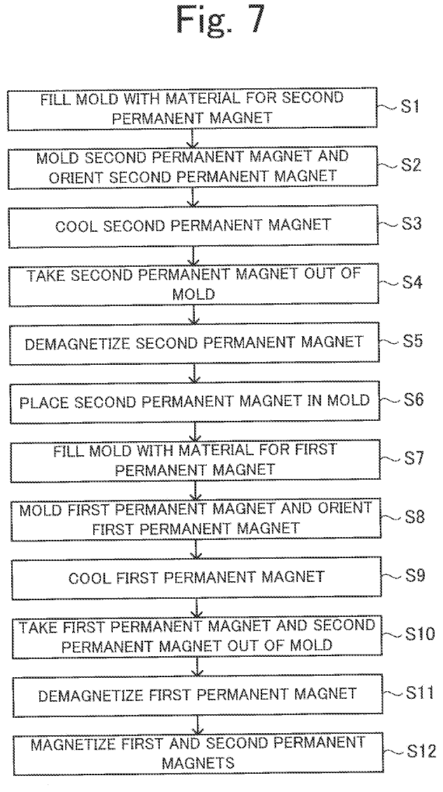

FIG. 7 is a flowchart depicting an example of a process for fabricating the rotor 2.

In first step S1, a mold for a second permanent magnet 22 is filled with a material for the second permanent magnet 22.

In second step S2, a second permanent magnet 22 is molded, and the second permanent magnet 22 is oriented. For example, a magnetic field of polar anisotropy is generated inside the mold for the second permanent magnet 22 by using a magnet for magnetization. Accordingly, the second permanent magnet 22 is molded and oriented. The second permanent magnet 22 is molded by, for example, injection molding. In this embodiment, the second permanent magnet 22 is molded to have orientation of polar anisotropy and have 3×2n magnetic poles. In other words, easy axes of magnetization are formed in the second permanent magnet 22 such that the second permanent magnet 22 has 3×2n magnetic poles.

First step S1 and second step S2 may be performed at the same time. In this case, a magnetic field of polar anisotropy is previously generated inside the mold for the second permanent magnet 22 by using a magnet for magnetization, for example. In the state where the field of polar anisotropy is generated inside the mold for the second permanent magnet 22, the mold for the second permanent magnet 22 is filled with a material for the second permanent magnet 22 by injection molding. Accordingly, the second permanent magnet 22 is molded and oriented.

In third step S3, the second permanent magnet 22 in the mold is cooled.

In fourth step S4, the second permanent magnet 22 is taken out of the mold.

Since a mold corresponding to the shape of each of the first permanent magnets 21 is formed in the mold for the second permanent magnet 22, the shape of each of the first permanent magnets 21 is molded on the outer peripheral surface of the second permanent magnet 22 concurrently with obtainment of the second permanent magnet 22.

In fifth step S5, the second permanent magnet 22 is demagnetized. For example, the second permanent magnet 22 is demagnetized by a demagnetizer.

In sixth step S6, the second permanent magnet 22 is placed in a mold for the first permanent magnets 21.

In seventh step S7, the mold for the first permanent magnets 21 is filled with a material for the first permanent magnets 21.

In eighth step S8, the first permanent magnets 21 are molded and oriented. For example, a magnetic field of polar anisotropy is generated inside the mold for the first permanent magnets 21 by using a magnet for magnetization. Accordingly, the plurality of first permanent magnets 21 are molded and oriented. Each of the first permanent magnets 21 is molded by, for example, injection molding. In this embodiment, 2n first permanent magnets 21 are formed on the outer peripheral surface of the second permanent magnet 22 to form part of the outer peripheral surface of the rotor 2, and the first permanent magnets 21 are molded to have orientation of polar anisotropy.

Seventh step S7 and eighth step S8 may be performed at the same time. In this case, a magnetic field of polar anisotropy is generated inside the mold for the first permanent magnets 21 beforehand by using a magnet for magnetization, for example. In the state where the field of polar anisotropy is generated inside the mold for the first permanent magnets 21, the mold for the first permanent magnets 21 is filled with a material for the first permanent magnets 21 by injection molding. Accordingly, each of the first permanent magnets 21 is molded and oriented at the same time.

In ninth step S9, the first permanent magnets 21 in the mold are cooled.

In tenth step S10, the first permanent magnets 21 and the second permanent magnet 22 are taken out of the mold.

In eleventh step S11, the first permanent magnets 21 are demagnetized. For example, the first permanent magnets 21 are demagnetized by a demagnetizer.

In twelfth step S12, the first permanent magnets 21 and the second permanent magnet 22 are magnetized. For example, the first permanent magnets 21 and the second permanent magnet 22 are magnetized by a magnetizer such that the first permanent magnets 21 and the second permanent magnet 22 have polar anisotropy.

In this manner, the rotor 2 is obtained.

Advantages of the rotor 2 according to the first embodiment will be described.

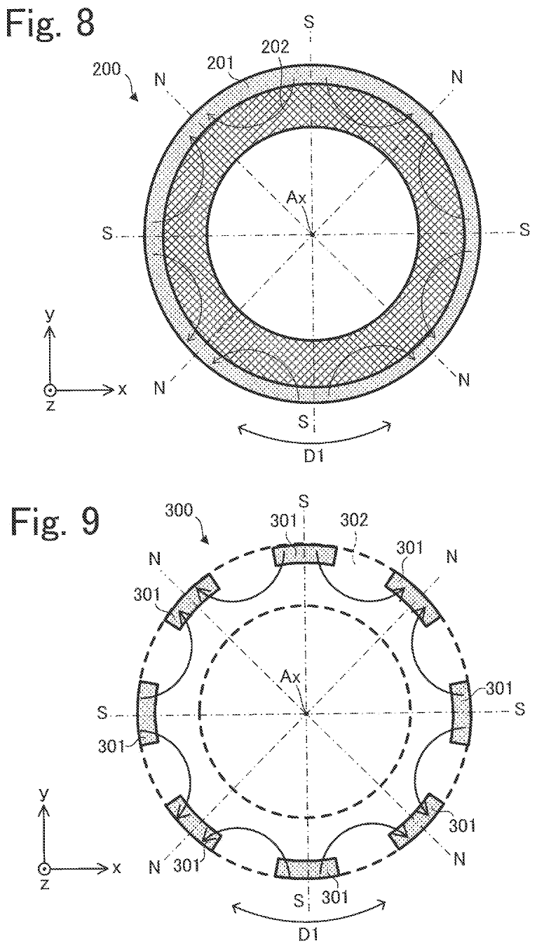

FIG. 8 is a cross-sectional view schematically illustrating a structure of a rotor 200 according to a first comparative example. In FIG. 8, arrows on the rotor 200 represent directions of main magnetic flux. In the rotor 200 according to the first comparative example illustrated in the FIG. 8, a ring-shaped rare earth bonded magnet 201 having higher magnetic force than that of a cylindrical ferrite bonded magnet 202 is disposed on the outer peripheral surface of the ferrite bonded magnet 202. The ring-shaped rare earth bonded magnet 201 extends in the circumferential direction of the rotor 200, and the thickness of the rare earth bonded magnet 201 in the xy plane is uniform in the axial direction of the rotor 200. That is, the ring-shaped rare earth bonded magnet 201 forms the entire outer peripheral surface of the rotor 200.

On the other hand, the rotor 2 according to the first embodiment includes the plurality of first permanent magnets 21. The first permanent magnets 21 form part of the outer peripheral surface of the rotor 2, and do not form the entire outer peripheral surface of the rotor 2. Accordingly, the amount of the first permanent magnets 21 having high magnetic force can be reduced, as compared to the rotor 200 according to the first comparative example. In a case where the first permanent magnets 21 are expensive rare earth bonded magnets, the amount of rare earth bonded magnets can be reduced as compared to the rotor 200 according to the first comparative example, and thus, costs for the rotor 2 can be reduced.

FIG. 9 is a diagram illustrating a structure of first permanent magnets 301 and orientation of the first permanent magnets 301 in a rotor 300 according to a second comparative example.

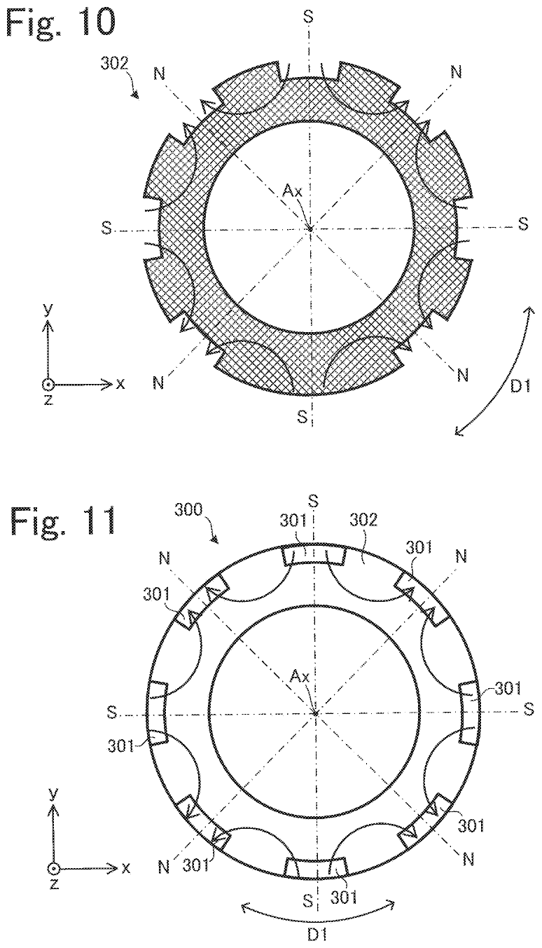

FIG. 10 is a diagram illustrating a structure and orientation of a second permanent magnet 302 in the rotor 300 according to the second comparative example.

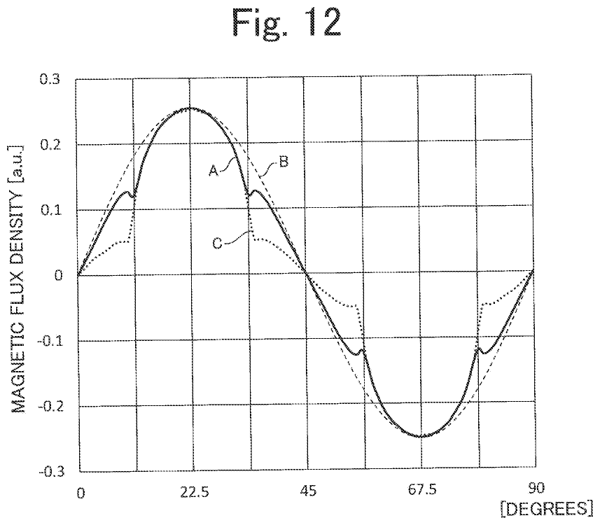

FIG. 11 is a diagram illustrating a structure and orientation of the rotor 300 according to the second comparative example.

FIG. 12 is a graph showing changes in surface magnetic flux density. In FIG. 12, the vertical axis represents a surface magnetic flux density [a.u.] (specifically, a surface magnetic flux density at a position indicated by line C5 in FIG. 1), and the horizontal axis represents a mechanical angle [degrees]. In FIG. 12, “A” represents a surface magnetic flux density of the rotor 2 according to the first embodiment, “B” represents a surface magnetic flux density of the rotor 200 according to the first comparative example, and “C” represents a surface magnetic flux density of the rotor 300 according to the second comparative example.

In the rotor 200 according to the first comparative example, the rare earth bonded magnet 201 and the ferrite bonded magnet 202 are respectively different in shape from each of the first permanent magnets and the second permanent magnet 22 of the rotor 2 according to the first embodiment.

In the rotor 300 according to the second comparative example, the first permanent magnets 301 and the second permanent magnet 302 are the same as the first permanent magnets and the second permanent magnet 22 of the rotor 2 according to the first embodiment in terms of shape, but the number of magnetic poles of the second permanent magnet 302 of the rotor 300 according to the second comparative example is different from the number of magnetic poles of the second permanent magnet 22 of the rotor 2 according to the first embodiment. The number of magnetic poles of the second permanent magnet 22 of the rotor 2 according to the first embodiment is 24, and the number of magnetic poles of the second permanent magnet 302 of the rotor 300 according to the second comparative example is 8.

As shown in FIG. 12, in the rotor 200 according to the first comparative example indicated by broken line B, a sine wave that is uniform in the circumferential direction is formed. On the other hand, in the rotor 3 according to the second comparative example indicated by broken line C, an irregular sine wave is formed. Thus, in the rotor 300 according to the second comparative example, vibrations and noise are large during rotation of the rotor 300, as compared to the first comparative example.

On the other hand, in the rotor 2 according to the first embodiment, the second permanent magnet 22 has 3×2n magnetic poles (24 magnetic poles in this embodiment), and the magnetic flux density on the outer peripheral surface of the rotor 2 is at maximum at the boundary between each first permanent magnet 21 and the second permanent magnet 22. Accordingly, as shown in FIG. 12, a relatively uniform sine wave is formed. That is, in the rotor 2 according to the first embodiment, an abrupt change in surface magnetic flux density is suppressed, as compared to the second comparative example. Accordingly, vibrations and noise can be reduced during rotation of the rotor 2, as compared to the second comparative example.

As described above, in the rotor 2 according to the first embodiment, the amount of the first permanent magnets 21 having high magnetic force can be reduced, as compared to the rotor 200 according to the first comparative example. Specifically, in the rotor 2 according to the first embodiment, since the first permanent magnets 21 form part of the outer peripheral surface of the rotor 2, the amount of the first permanent magnets 21 can be reduced by about 20%, as compared to the rotor 200 according to the comparative example. In general, a material unit price of rare earth magnets is greater than or equal to 10 times that of ferrite magnets. Thus, in a case where magnets including rare earth magnets (e.g., rare earth bonded magnets) are used as the first permanent magnets 21 and a magnet including a ferrite magnet (e.g., a ferrite bonded magnet) is used as the second permanent magnet 22, even when the amount of the second permanent magnet 22 is large, costs for the first permanent magnets 21 can be significantly reduced. As a result, costs for the rotor 2 can be significantly reduced.

In addition, as described above, in the rotor 2 according to the first embodiment, even when the amount of the first permanent magnets 21 having high magnetic force is reduced, an abrupt change in surface magnetic flux density is suppressed. Accordingly, vibrations and noise can be reduced during rotation of the rotor 2, as compared to the second comparative example.

With the method for fabricating the rotor 2, the rotor 2 having the advantages described above can be fabricated.

### First Variation

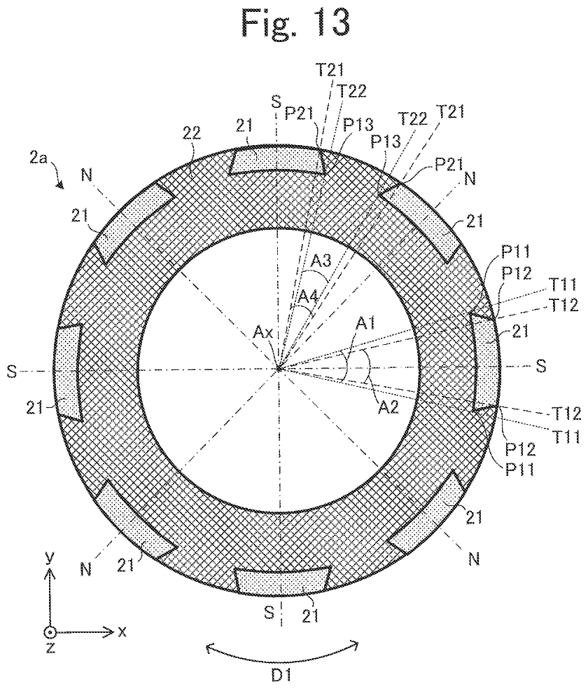

FIG. 13 is a cross-sectional view schematically illustrating a structure of a rotor 2a according to a first variation.

In the xy plane, an angle A1 formed by two lines T11 passing through a rotation center (i.e., an axis Ax) of the rotor 2a and both ends P11 of the inner peripheral surface of each first permanent magnet 21 is larger than an angle A2 formed by two lines T12 passing through the rotation center of the rotor 2a and both ends P12 of the outer peripheral surface of the first permanent magnet 21. The inner peripheral surfaces of the first permanent magnets 21 are the radially inner surfaces of the first permanent magnets 21. The outer peripheral surfaces of the first permanent magnets 21 are the radially outer surfaces of the first permanent magnets 21.

In the xy plane, the inner peripheral surface of each first permanent magnet 21 is longer than the outer peripheral surface of the first permanent magnet 21. Accordingly, a centrifugal force generated during rotation of the rotor 2a can prevent detachment of the first permanent magnets 21 from the second permanent magnet 22.

In the xy plane, an angle A3 is smaller than an angle A4. Accordingly, a centrifugal force generated during rotation of the rotor 2a can prevent detachment of the first permanent magnets 21 from the second permanent magnet 22. In the xy plane, the angle A3 is an angle formed by two lines T22 passing through opposed ends P13 of the inner peripheral surfaces of two first permanent magnets 21, and these end ends P13 face each other in the circumferential direction of the rotor 2. In other words, the two ends P13 are adjacent to each other in the circumferential direction of the rotor 2. In the xy plane, the angle A4 is an angle formed by two lines T21 passing through both ends P21 of the outer peripheral surface of the second permanent magnet 22 between two first permanent magnets 21. The outer peripheral surface of the second permanent magnet 22 is the surface of the second permanent magnet 22 facing outward in the radial direction.

The rotor 2a according to the first variation has the same advantages as the rotor 2 according to the first embodiment.

### Second Variation

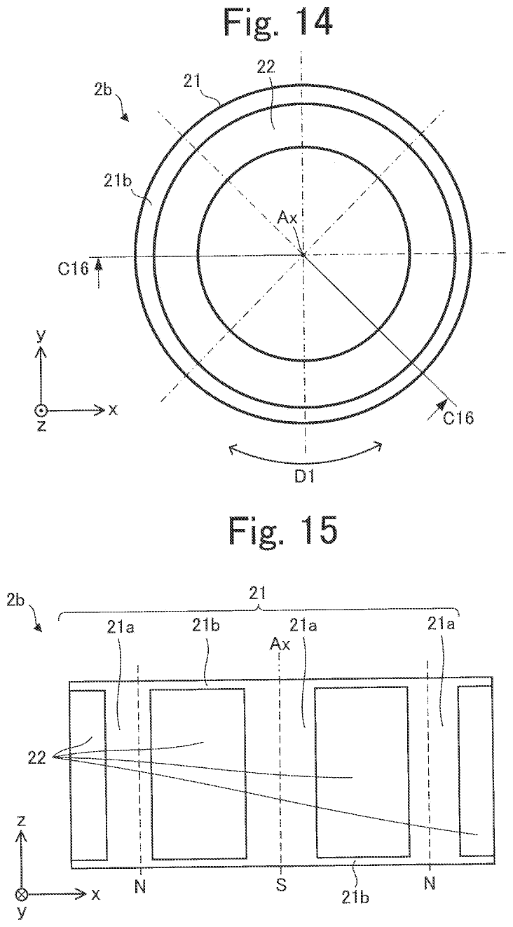

FIG. 14 is a plan view schematically illustrating a structure of a rotor 2b according to a second variation.

FIG. 15 is a side view schematically illustrating the structure of the rotor 2b according to the second variation.

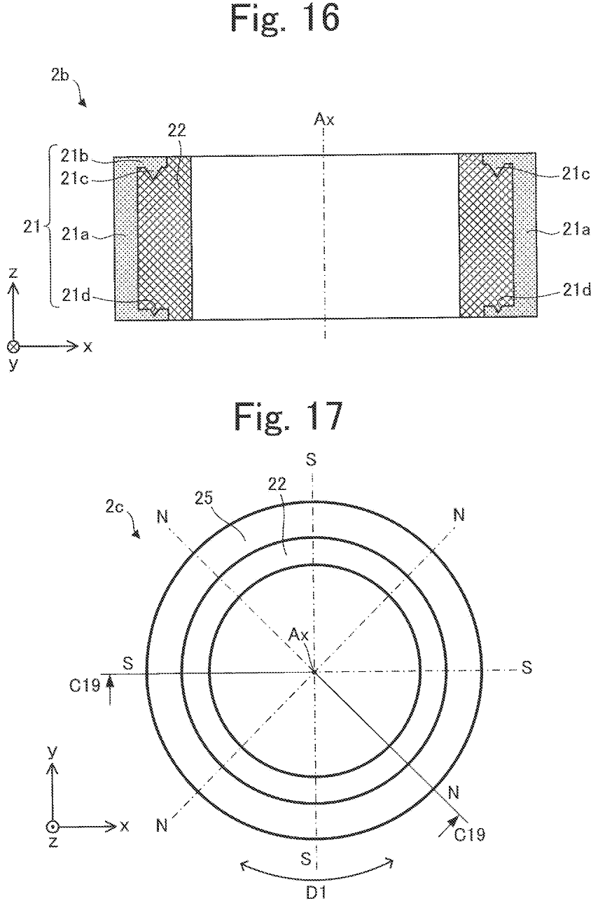

FIG. 16 is a cross-sectional view schematically illustrating the structure of the rotor 2b according to the second variation. Specifically, FIG. 16 is a cross-sectional view taken along line C16-C16 in FIG. 14.

In the rotor 2b according to the second variation, the first permanent magnet 21 is a single structure. The first permanent magnet 21 includes a plurality of bodies 21a and at least one ring-shaped portion 21b. In the example illustrated in FIG. 15, the first permanent magnet 21 has two ring-shaped portions 21b. The plurality of bodies 21a correspond to the first permanent magnets 21 in the first embodiment (e.g., the first permanent magnets 21 illustrated in FIG. 1). Thus, the bodies 21a form part of the outer peripheral surface of the rotor 2b, and are magnetized to have polar anisotropy. Part of a second permanent magnet 22 is present between two bodies 21a adjacent to each other in the circumferential direction.

In the example illustrated in FIG. 15, the two ring-shaped portions 21b are integrated as a single member (also referred to as a single structure) with the plurality of bodies 21a. Thus, in the second variation, the rotor 2b includes one first permanent magnet 21 and one second permanent magnet 22. In the example illustrated in FIG. 15, the ring-shaped portions 21b are located at both ends of the first permanent magnet 21 in the axial direction. It should be rioted that the ring-shaped portions 21b may be located at one end of the first permanent magnet 21 in the axial direction. The ring-shaped portions 21b cover the whole or part of end portions of the second permanent magnet 22 in the axial direction of the rotor 2b.

As illustrated in FIG. 16, each ring-shaped portion 21b may include at least one projection 21c or at least one recess 21d. Each ring-shaped portion 21b may include both of the at least one projection 21c and the at least one recess 21d. The projection 21c projects toward the second permanent magnet 22. For example, the projection 21c is engaged with a recess formed on the second permanent magnet 22. For example, the recess 21d is engaged with a projection formed on the second permanent magnet 22.

In general, when the temperature of the rotor changes, magnets deform in some cases. In such cases, one of two types of magnets might be detached from the rotor because of a difference in thermal shrinkage. In the second variation, since the rotor 2b has the ring-shaped portions 21b, when the temperature of the rotor 2b changes, even in a case where the first permanent magnet 21 or the second permanent magnet 22 deforms because of a difference in thermal shrinkage, it is possible to prevent detachment of the first permanent magnet 21 (especially the bodies 21a) from the second permanent magnet 22. In addition, a centrifugal force generated during rotation of the rotor 2b can prevent detachment of the first permanent magnet 21 (especially the bodies 21a) from the second permanent magnet 22.

Furthermore, since each ring-shaped portion 21b has at least one projection 21c to be engaged with the second permanent magnet 22, the first permanent magnet 21 can be firmly fixed to the second permanent magnet 22. Accordingly, detachment of the first permanent magnet 21 (especially the bodies 21a) from the second permanent magnet 22 can be effectively prevented.

Moreover, since each ring-shaped portion 21b has at least one recess 21d to be engaged with the second permanent magnet 22, the first permanent magnet 21 can be firmly fixed to the second permanent magnet 22. Accordingly, detachment of the first permanent magnet 21 (especially the bodies 21a) from the second permanent magnet 22 can be effectively prevented.

The rotor 2b according to the second variation has the same advantages as the rotor 2 according to the first embodiment.

### Third Variation

FIG. 17 is a plan view schematically illustrating a structure of a rotor 2c according to a third variation.

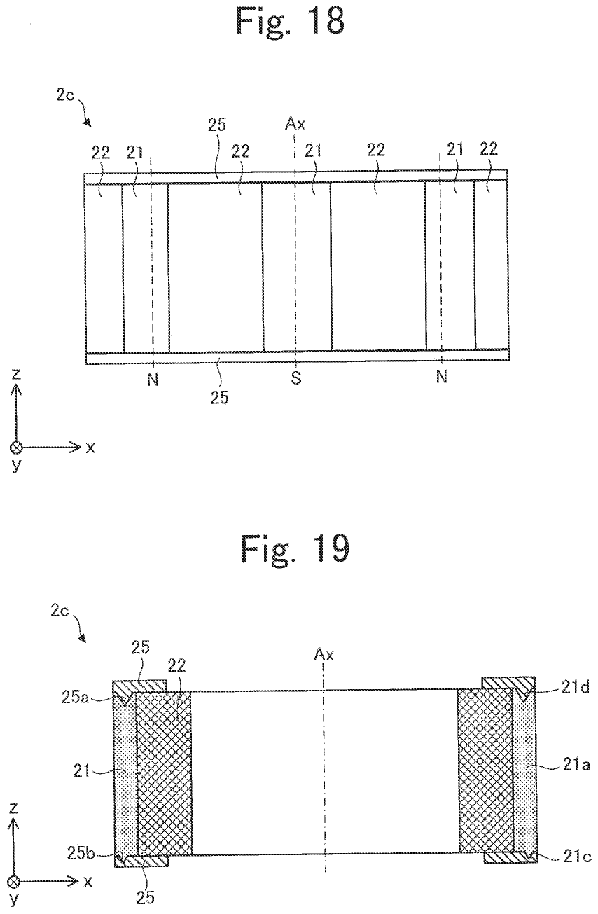

FIG. 18 is a side view schematically illustrating the structure of the rotor 2c according to the third variation.

FIG. 19 is a cross-sectional view schematically illustrating the structure of the rotor 2c according to the third variation. Specifically, FIG. 19 is a cross-sectional view taken along line C19-C19 in FIG. 17.

The rotor 2c according to the third variation further includes at least one resin 25. For example, the resin 25 can be molded integrally with a rib for fixing a shaft in the rotor 2c.

In the example illustrated in FIG. 18, the resin 25 is fixed to both ends of each first permanent magnet 21 in the axial direction of the rotor 2c. That is, in the example illustrated in FIG. 18, the rotor 2c includes two resins 25. It should be noted that the resins 25 fixed to both ends of each first permanent magnet 21 in the axial direction of the rotor 2c may be integrated as a single member. One resin 25 may be fixed to one end of each first permanent magnet 21 in the axial direction of the rotor 2c. In the example illustrated in FIG. 17, each resin 25 is a ring-shaped resin in the xy plane. Each resin 25 covers end portions of the first permanent magnets 21 in the axial direction of the rotor 2c and the whole or part of end portions of the second permanent magnet 22 in the axial direction.

As illustrated in FIG. 19, each resin 25 may include at least one projection 25a or at least one recess 25b. Each resin 25 may include both of the at least one projection 25a and the at least one recess 25b. The projection 25a projects toward the second permanent magnet 22. For example, the projection 25a is engaged with a recess formed on the first permanent magnet 21 or the second permanent magnet 22. For example, the recess 25b is engaged with a projection formed on the first permanent magnet 21 or the second permanent magnet 22.

In general, when the temperature of a rotor changes, magnets deform in some cases. In such cases, one of two types of magnets might be detached from the rotor because of a difference in thermal shrinkage. In the third variation, since the rotor 2c includes the resins 25, when the temperature of the rotor 2c changes, even in the case where the first permanent magnet 21 or the second permanent magnet 22 deforms because of a difference in thermal shrinkage, it is possible to prevent detachment of the first permanent magnet 21 from the second permanent magnet 22. In addition, a centrifugal force generated during rotation of the rotor 2c can prevent detachment of the first permanent magnet 21 from the second permanent magnet 22.

Furthermore, since each resin 25 includes at least one projection 25a to be engaged with the first permanent magnet 21 or the second permanent magnet 22, the resin 25 can be firmly fixed to the first permanent magnet 21 or the second permanent magnet 22 with the resin 25 covering the first permanent magnet 21. Accordingly, detachment of the first permanent magnet 21 from the second permanent magnet 22 can be effectively prevented.

Furthermore, since each resin 25 includes at least one recess 25b to be engaged with the first permanent magnet 21 or the second permanent magnet 22, the resin 25 can be firmly fixed to the first permanent magnet 21 or the second permanent magnet 22 with the resin 25 covering the first permanent magnet 21. Accordingly, detachment of the first permanent magnet 21 from the second permanent magnet 22 can be effectively prevented.

Moreover, since the rotor 2c according to the third variation includes at least one resin 25, the amount of the first permanent magnet 21 can be reduced, as compared to the rotor 2b according to the second variation.

The rotor 2c according to the third variation has the same advantages as the rotor 2 according to the first embodiment.

### Fourth Variation

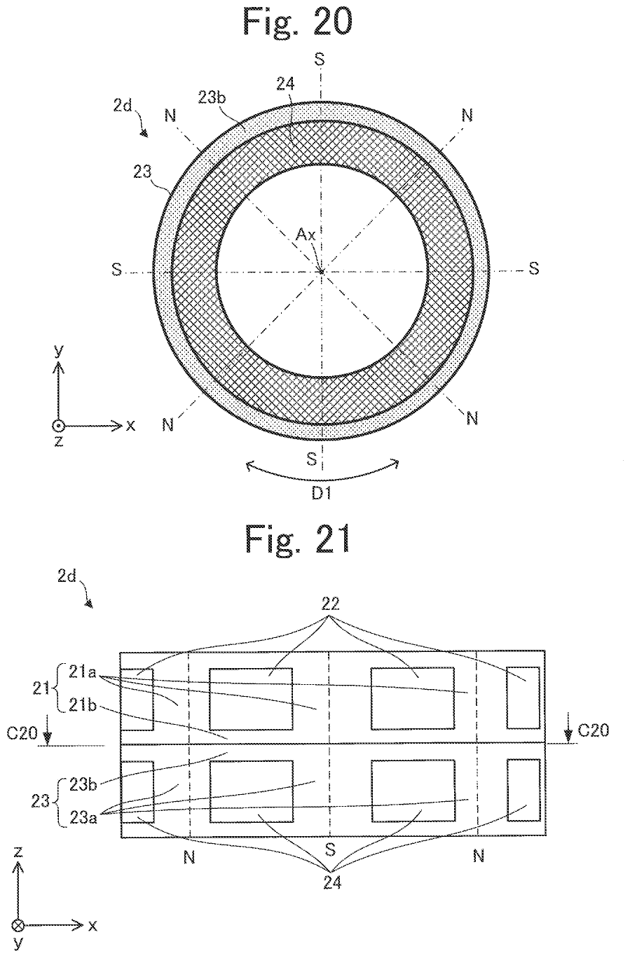

FIG. 20 is a cross-sectional view schematically illustrating a structure of a rotor 2d according to a fourth variation. Specifically, FIG. 20 is a cross-sectional view taken along line C20-C20 in FIG. 21.

FIG. 21 is a side view schematically illustrating the structure of the rotor 2d according to the fourth variation.

The rotor 2d according to the fourth variation includes at least one first permanent magnet 21, one second permanent magnet 22, at least one third permanent magnet 23, and at least one fourth permanent magnet 24. In the example illustrated in FIG. 21, the structure of each third permanent magnet 23 is the same as the structure of the first permanent magnet 21, and magnetic properties of each third permanent magnet 23 are the same as magnetic properties of each first permanent magnet 21. The structure of each fourth permanent magnet 24 is the same as the structure of the second permanent magnet 22, and magnetic properties of each fourth permanent magnet 24 are the same as magnetic properties of each second permanent magnet 22.

The third permanent magnet 23 may be a single structure or may be divided into a plurality of parts. The fourth permanent magnet 24 may be a single structure or may be divided into a plurality of parts.

As illustrated in FIG. 21, the third permanent magnet 23 and the fourth permanent magnet 24 are stacked on the first permanent magnet 21 and the second permanent magnet 22 in the axial direction of the rotor 2d.

That is, each third permanent magnet 23 forms part of the outer peripheral surface of the rotor 2d, and is magnetized to have polar anisotropy. Each third permanent magnet 23 is, for example, a bonded magnet as a mixture of a rare earth magnet and a resin, that is, a rare earth bonded magnet. Each third permanent magnet 23 has higher magnetic force than that of the fourth permanent magnet 24. The rare earth magnet is, for example, a magnet containing neodymium (Nd)-iron (Fe)-boron (B) or a magnet containing samarium (Sm)-iron (Fe)-nitrogen (N). The resin is, for example, a nylon resin, a polyphenylene sulfide (PPS) resin, or an epoxy resin.

The fourth permanent magnet 24 is adjacent to the third permanent magnet 23 in the circumferential direction of the rotor 2d, and forms part of the outer peripheral surface of the rotor 2d. Specifically, part of the fourth permanent magnet 24 is adjacent to the third permanent magnet 23 in the circumferential direction of the rotor 2d, and another part of the fourth permanent magnet 24 is located at the inner side of the third permanent magnet 23 in the radial direction of the rotor 2d. Thus, the fourth permanent magnet 24 is a ring-shaped magnet.

The fourth permanent magnet 24 is magnetized to have polar anisotropy. The fourth permanent magnet 24 is a magnet that is of a different type from the third permanent magnet 23. Specifically, the fourth permanent magnet 24 is, for example, a bonded magnet as a mixture of a ferrite magnet and a resin, that is, a ferrite bonded magnet. The resin is, for example, a nylon resin, a polyphenylene sulfide (PPS) resin, or an epoxy resin. The fourth permanent magnet 24 has lower magnetic force than that of each third permanent magnet. The fourth permanent magnet 24 has 3×2n magnetic poles, in a manner similar to the second permanent magnet 22.

In the rotor 2d according to the fourth variation, the first permanent magnet 21 is a single structure. The first permanent magnet 21 includes a plurality of bodies 21a, at least one ring-shaped portion 21b (also referred to as a first ring-shaped portion in the fourth variation). The plurality of bodies 21a correspond to the first permanent magnets 21 in the first embodiment (e.g., the first permanent magnets 21 illustrated in FIG. 1). Thus, the bodies 21a form part of the outer peripheral surface of the rotor 2d and are magnetized to have polar anisotropy. Part of the second permanent magnet 22 is present between two bodies 21a adjacent to each other in the circumferential direction.

The ring-shaped portion 21b is integrated with the plurality of bodies 21a as a single member. Thus, in the fourth variation, the rotor 2d includes one first permanent magnet 21 and one second permanent magnet 22. In the example illustrated in FIG. 21, the ring-shaped portion 21b is formed at an end portion of the first permanent magnet 21 in the axial direction. The ring-shaped portion 21b covers an end portion of the second permanent magnet 22 in the axial direction of the rotor 2d.

In the rotor 2d according to the fourth variation, the third permanent magnet 23 is a single structure. The third permanent magnet 23 includes a plurality of bodies 23a, at least one ring-shaped portion 23b (also referred to as a second ring-shaped portion in the fourth variation). The plurality of bodies 23a correspond to the first permanent magnets 21 in the first embodiment (e.g., the first permanent magnets 21 illustrated in FIG. 1). Thus, the bodies 23a form part of the outer peripheral surface of the rotor 2d and are magnetized to have polar anisotropy. Part of the fourth permanent magnet 24 is present between two bodies 23a adjacent to each other in the circumferential direction.

The ring-shaped portion 23b is integrated with the plurality of bodies 23a as a single member. Thus, in the fourth variation, the rotor 2d includes one third permanent magnet 23 and one fourth permanent magnet 24. In the example illustrated in FIG. 21, the ring-shaped portion 23b is formed at an end portion of the third permanent magnet 23 in the axial direction. The ring-shaped portion 23b covers an end portion of the fourth permanent magnet 24 in the axial direction of the rotor 2d.

In the axial direction of the rotor 2d, the ring-shaped portion 21b faces the ring-shaped portion 23b. Accordingly, the proportion of the first permanent magnet 21 and the third permanent magnet 23 can be increased in a center portion of the rotor 2d in the axial direction. As a result, in an electric motor, the amount of magnetic flux flowing from the rotor 2d into a stator increases, and thus an output of the electric motor can be increased.

In the electric motor, the length of the rotor 2d in the axial direction is preferably larger than the length of the stator in the axial direction. Accordingly, leakage of magnetic flux from the rotor 2d can be reduced. Specifically, in the electric motor, the amount of magnetic flux flowing from the rotor 2d into the stator increases, and thus an output of the electric motor can be increased.

In the fourth variation, the rotor 2d includes two layers of magnets. In other words, the rotor 2d is divided into two layers. Specifically, the rotor 2d includes a first layer constituted by the first permanent magnet 21 and the second permanent magnet 22, and a second layer constituted by the third permanent magnet 23 and the fourth permanent magnet 24. Thus, since the rotor 2d includes the plurality of layers, an eddy-current loss in the rotor 2d can be reduced.

In the xy plane, the magnetic pole center position (e.g., the position of a north pole) of the first permanent magnet 21 preferably coincides with the magnetic pole center position (e.g., the position of a north pole) of the third permanent magnet 23. Accordingly, a magnetic flux density at each magnetic pole center position of the rotor 2d can be increased, and thus, a larger amount of magnetic flux flows from the rotor 2d into the stator in the electric motor, and an output of the electric motor can be enhanced. Magnetic pole center positions of the first permanent magnet 21 and magnetic pole center positions of the third permanent magnet 23 are positions indicated by the broken line in FIG. 21.

The rotor 2d according to the fourth variation has the same advantages as the rotor 2 according to the first embodiment.

### Fifth Variation

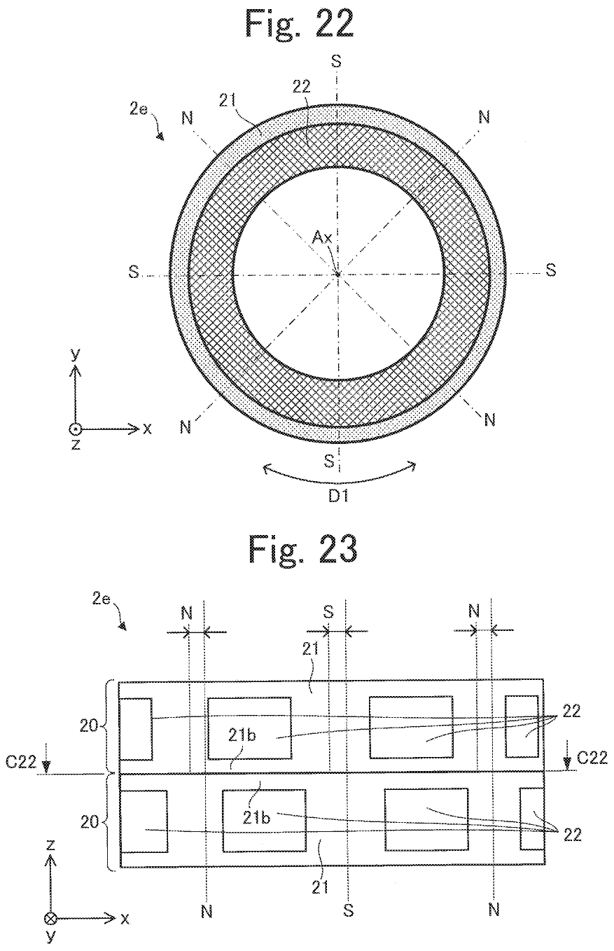

FIG. 22 is a cross-sectional view schematically illustrating the structure of a rotor 2e according to a fifth variation. FIG. 22 is a cross-sectional view taken along line C22-C22 in FIG. 23.

FIG. 23 is a side view schematically illustrating the structure of the rotor 2e according to the fifth variation.

The rotor 2e according to the fifth variation has 2n (n is a natural number) magnetic poles, as in the first embodiment and the variations thereof described above. In addition, the rotor 2e includes a plurality of layered magnets 20 from two to m (m is a natural number and a divisor of n) layers stacked in the axial direction. In the example illustrated in FIG. 23, n=4 and m=2. That is, in the example illustrated in FIG. 23, the rotor 2e includes two layers of layered magnets 20.

Each layered magnet 20 of the plurality of layered magnets 20 includes at least one first permanent magnet 21 and one second permanent magnet 22.

As illustrated in FIG. 23, the plurality of layered magnets 20 are stacked in the axial direction of the rotor 2e. As described above, the rotor 2e includes two layers of magnets. In other words, the rotor 2e is divided into two layers. Thus, since the rotor 2e includes the plurality of layers, an eddy-current loss in the rotor 2e can be reduced.

In the axial direction of the rotor 2e, a ring-shaped portion 21b of each first permanent magnet 21 faces a ring-shaped portion 21b of another first permanent magnet 21. Accordingly, a proportion of the first permanent magnets 21 can be increased in a center portion of the rotor 2e in the axial direction. As a result, in an electric motor, a larger amount of magnetic flux flows from the rotor 2e into a stator, and thus an output of the electric motor can be thereby increased.

In each first permanent magnet 21 of the plurality of layered magnets 20, supposing one cycle is an angle between adjacent north poles in the xy plane, positions of north poles of two first permanent magnets 21 adjacent to each other in the axial direction are shifted from each other by n/m cycles in the circumferential direction. Positions of south poles of two first permanent magnets 21 adjacent to each other in the axial direction are also shifted from each other by n/m cycles in the circumferential direction. Accordingly, even in a case where the layered magnets 20 have variations in orientation, uniform orientation can be obtained in the rotor 2e. As a result, in a manner similar to the example indicated by “A” in FIG. 12, an abrupt change in the flux density can be suppressed in the circumferential direction in the entire rotor 2e, and vibrations and noise in the electric motor can be reduced.

The rotor 2e according to the fifth variation has the same advantages as the rotor 2 according to the first embodiment.

### Second Embodiment

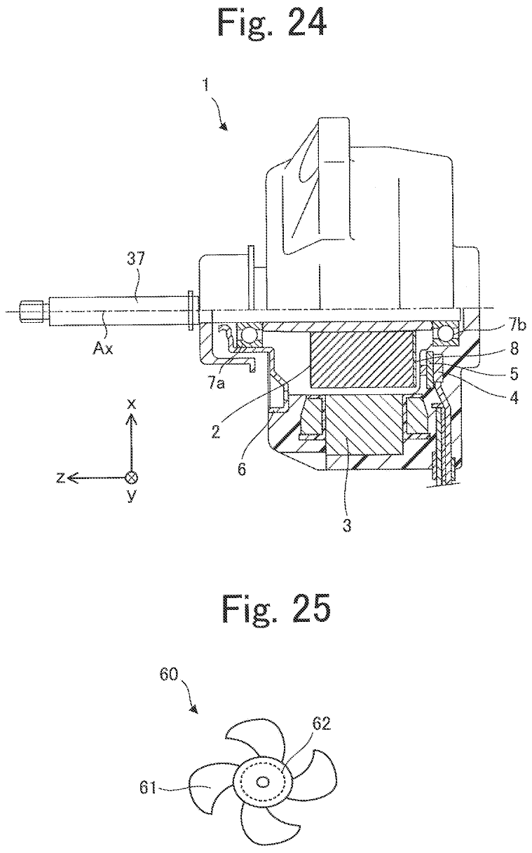

FIG. 24 is a partial cross-sectional view schematically illustrating a structure of an electric motor 1 according to a second embodiment of the present invention.

The electric motor 1 includes the rotor 2 according to the first embodiment, and a stator 3. Instead of the rotor 2, the rotors 2a through 2j according to the variations of the first embodiment are applicable to the electric motor 1.

The electric motor 1 includes the rotor 2, the stator 3, a circuit board 4, a magnetic sensor 5 for detecting a rotation position of the rotor 2, a bracket 6, bearings 7a and 7b, a sensor magnet 8 as a magnet for detecting a rotation position of the rotor 2, and a shaft 37 fixed to the rotor 2. The electric motor 1 is, for example, a permanent magnet synchronous motor.

The rotor 2 is rotatably disposed inside the stator 3. An air gap is formed between the rotor 2 and the stator 3. The rotor 2 rotates about an axis Ax.

Since the electric motor 1 according to the second embodiment includes the rotor 2 according to the first embodiment (including the variations thereof), the same advantages as those of the rotor 2 described in the first embodiment (including advantages of the variations thereof) can be obtained.

The electric motor 1 according to the second embodiment includes the rotor 2 according to the first embodiment, and thus, efficiency of the electric motor 1 can be increased.

### Third Embodiment

FIG. 25 is a diagram schematically illustrating a structure of a fan 60 according to a third embodiment of the present invention.

The fan 60 includes a blade 61 and an electric motor 62. The fan 60 is also referred to as a blower. The electric motor 62 is the electric motor 1 according to the second embodiment. The blade 61 is fixed to a shaft of the electric motor 62. The electric motor 62 drives the blade 61. When the electric motor 62 is driven, the blade 61 rotates to generate an airflow. In this manner, the fan 60 is allowed to send air.

In the fan 60 according to the third embodiment, the electric motor 1 described in the second embodiment is applied to the electric motor 62, and thus, the same advantages as those described in the second embodiment can be obtained. In addition, efficiency of the fan 60 can be enhanced.

### Fourth Embodiment

An air conditioner 50 (also referred to as a refrigeration air conditioning apparatus or a refrigeration cycle apparatus) according to a fourth embodiment of the present invention will be described.

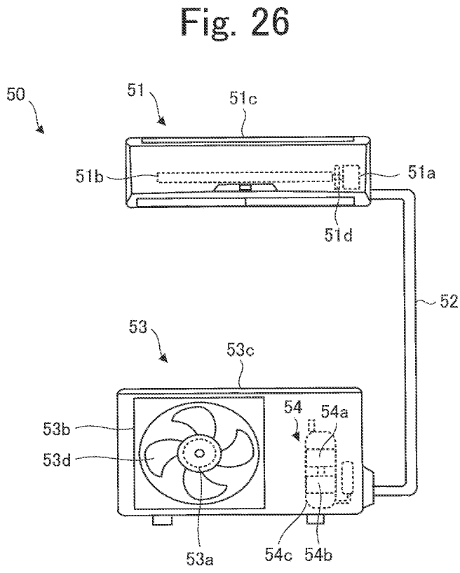

FIG. 26 is a diagram schematically illustrating a configuration of the air conditioner 50 according to the fourth embodiment.

The air conditioner 50 according to the fourth embodiment includes an indoor unit 51 as a blower (first blower), a refrigerant pipe 52, and an outdoor unit 53 as a blower (second blower) connected to the indoor unit 51 through the refrigerant pipe 52.

The indoor unit 51 includes an electric motor 51a (e.g., the electric motor 1 according to the second embodiment), an air blowing unit 51b that supplies air when being driven by the electric motor 51a, and a housing 51c covering the electric motor 51a and the air blowing unit 51b. The air blowing unit 51b includes, for example, a blade 51d that is driven by the electric motor 51a. For example, the blade 51d is fixed to a shaft of the electric motor 51a, and generates an airflow.

The outdoor unit 53 includes an electric motor 53a (e.g., the electric motor 1 according to the second embodiment), an air blowing unit 53b, a compressor 54, and a heat exchanger (not shown). When the air blowing unit 53b is driven by the electric motor 53a, the air blowing unit 53b supplies air. The air blowing unit 53b includes, for example, a blade 53d that is driven by the electric motor 53a. For example, the blade 53d is fixed to a shaft of the electric motor 53a, and generates an airflow. The compressor 54 includes an electric motor 54a (e.g., the electric motor 1 according to the second embodiment), a compression mechanism 54b (e.g., a refrigerant circuit) that is driven by the electric motor 54a, and a housing 54c covering the electric motor 54a and the compression mechanism 54b.

In the air conditioner 50, at least one of the indoor unit 51 or the outdoor unit 53 includes the electric motor 1 described in the second embodiment. Specifically, as a driving source of an air blowing unit, the electric motor 1 described in the second embodiment is applied to at least one of the electric motors 51a or 53a. That is, the indoor unit 51 or the outdoor unit 53 may include the electric motor 1 described in the second embodiment, and each of the indoor unit 51 and the outdoor unit 53 may include the electric motor 1 described in the second embodiment. In addition, the electric motor 1 described in the second embodiment may be applied to the electric motor 54a of the compressor 54.

The air conditioner 50 is capable of performing a cooling operation of sending cold air from the indoor unit 51 or a heating operation of sending hot air, for example. In the indoor unit 51, the electric motor 51a is a driving source for driving the air blowing unit 51b. The air supply unit 51b is capable of sending conditioned air.

In the air conditioner 50 according to the fourth embodiment, the electric motor 1 described in the second embodiment is applied to at least one of the electric motors 51a or 53a, and thus, the same advantages as those described in the second embodiment can be obtained. In addition, efficiency of the air conditioner 50 can be enhanced.

Furthermore, with the use of the electric motor 1 according to the second embodiment as a driving source of a blower (e.g., the indoor unit 51), the same advantages as those described in the second embodiment can be obtained. Accordingly, efficiency of the blower can be enhanced. The blower including the electric motor 1 according to the second embodiment and the blade (e.g., the blade 51d or 53d) driven by the electric motor 1 can be used alone as a device for supplying air. This blower is also applicable to equipment except for the air conditioner 50.

In addition, the electric motor 1 according to the second embodiment is used for a driving source of the compressor 54, thereby obtaining the same advantages as those described in the second embodiment. Moreover, efficiency of the compressor 54 can be enhanced.

The electric motor 1 described in the second embodiment can be mounted on equipment including a driving source, such as a ventilator, a household electrical appliance, or a machine tool, as well as the air conditioner 50.

Features of the embodiments and features of the variations described above can be combined as appropriate.

### DESCRIPTION OF REFERENCE CHARACTERS

1 electric motor, 2 rotor, 3 stator, 21 first permanent magnet, 22 second permanent magnet, 23 third permanent magnet, 24 fourth permanent magnet, 25 resin, 50 air conditioner, 51 indoor unit, 51d, 61 blade, 53 outdoor unit, 60 fan (blower).

1. A rotor having 2n (n is a natural number) magnetic poles, the rotor comprising:
at least one first permanent magnet forming part of an outer peripheral surface of the rotor and magnetized to have polar anisotropy; and
at least one second permanent magnet that is of a different type from the at least one first permanent magnet, is adjacent to the at least one first permanent magnet in a circumferential direction of the rotor, has lower magnetic force than magnetic force of the at least one first permanent magnet, and is magnetized to have polar anisotropy, wherein
the at least one second permanent magnet has 3×2n magnetic poles.

2. The rotor according to claim 1, wherein a magnetic flux density on the outer peripheral surface of the rotor is at maximum at a boundary between the at least one first permanent magnet and the at least one second permanent magnet.

3. The rotor according to claim 1, wherein
the at least one first permanent magnet comprises two first permanent magnets, and
in a plane orthogonal to an axial direction of the rotor, an angle formed by two lines passing through a rotation center of the rotor and opposed ends of inner peripheral surfaces of the two first permanent magnets is smaller than an angle formed by two lines passing through the rotation center and both ends of an outer peripheral surface of the second permanent magnet between the two first permanent magnets, the opposed ends facing each other in the circumferential direction of the rotor.

4. The rotor according to claim 1, wherein the at least one first permanent magnet includes a ring-shaped portion covering an end portion of the at least one second permanent magnet in an axial direction of the rotor.

5. The rotor according to claim 1, further comprising a resin covering an end portion of the at least one first permanent magnet in an axial direction of the rotor and an end portion of the at least one second permanent magnet in the axial direction.

6. The rotor according to claim 1, further comprising:
at least one third permanent magnet forming part of the outer peripheral surface of the rotor and magnetized to have polar anisotropy; and
at least one fourth permanent magnet that is of a different type from the at least one third permanent magnet, is adjacent to the at least one third permanent magnet in the circumferential direction, has lower magnetic force than magnetic force of the at least one third permanent magnet, and is magnetized to have polar anisotropy, wherein
the at least one first permanent magnet has a first ring-shaped portion covering an end portion of the second permanent magnet in an axial direction of the rotor,
the at least one third permanent magnet has a second ring-shaped portion covering an end portion of the fourth permanent magnet in the axial direction of the rotor, and
in the axial direction of the rotor, the first ring-shaped portion faces the second ring-shaped portion.

7. The rotor according to claim 6, wherein in a plane orthogonal to the axial direction of the rotor, a magnetic pole center position of the at least one first permanent magnet coincides with a magnetic pole center position of the at least one third permanent magnet.

8. A rotor having 2n (n is a natural number) magnetic poles and including a plurality of layered magnets including two to m (m is a natural number and a divisor of n) layers that are stacked in an axial direction, wherein
each layered magnet of the plurality of layered magnets includes
at least one first permanent magnet forming part of an outer peripheral surface of the rotor and magnetized to have polar anisotropy, and
at least one second permanent magnet that is of different type from the at least one first permanent magnet, is adjacent to the at least one first permanent magnet in a circumferential direction of the rotor, has lower magnetic force than magnetic force of the at least one first permanent magnet, and is magnetized to have polar anisotropy,
the at least one second permanent magnet has 3×2n magnetic poles, and
in each first permanent magnet of the plurality of layered magnets, supposing one cycle is an angle formed by adjacent north poles in a plane orthogonal to the axial direction of the rotor, positions of north poles of two first permanent magnets adjacent to each other in the axial direction are shifted from each other by n/m cycles in the circumferential direction.

9. The rotor according to claim 1, wherein the at least one first permanent magnet is a rare earth magnet.

10. The rotor according to claim 1, wherein the at least one second permanent magnet is a ferrite magnet.

11. An electric motor comprising:
a stator; and
the rotor as claimed in claim 1, the rotor being rotatably disposed inside the stator.

12. A blower comprising:
the electric motor as claimed in claim 11; and
a blade to be driven by the electric motor.

13. An air conditioner, comprising:
an indoor unit; and
an outdoor unit connected to the indoor unit, wherein
at least one of the indoor unit or the outdoor unit includes the electric motor as claimed in claim 11.

14. A manufacturing method for a rotator, the rotator including a first permanent magnet, and a second permanent magnet, the second permanent magnet being adjacent to the first permanent magnet in a circumferential direction and having lower magnetic force than magnetic force of the first permanent magnet, the rotor having 2n (n is a natural number) magnetic poles, the manufacturing method comprising:
filling a mold for the second permanent magnet with a material for the second permanent magnet;
forming the second permanent magnet such that the second permanent magnet is oriented to have polar anisotropy and has 3×2n magnetic poles;
placing the second permanent magnet in a mold for the first permanent magnet;
filling the mold for the first permanent magnet with a material for the first permanent magnet; and
molding the first permanent magnet such that the first permanent magnet is oriented to have polar anisotropy.

15. The rotor according to claim 8, wherein the at least one first permanent magnet is a rare earth magnet.

16. The rotor according to claim 8, wherein the at least one second permanent magnet is a ferrite magnet.

17. An electric motor comprising:
a stator; and
the rotor as claimed in claim 8, the rotor being rotatably disposed inside the stator.

18. A blower comprising:
the electric motor as claimed in claim 17; and
a blade to be driven by the electric motor.

19. An air conditioner, comprising:
an indoor unit; and
an outdoor unit connected to the indoor unit, wherein
at least one of the indoor unit or the outdoor unit includes the electric motor as claimed in claim 17.
